(19) United States
(12) Patent Application Publication
(10) Pub. No.: US 2009/0323516 A1
(43) Pub. Date: Dec. 31, 2009

(54) DIAGNOSING NETWORK PROBLEMS

(75) Inventors: Ranjita Bhagwan, Bangalore (IN); Bhavish Aggarwal, Punjab (IN); Venkata N. Padmanabhan, Bangalore (IN); Geoffrey M. Voelker, Del Mar, CA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/147,522

(22) Filed: Jun. 27, 2008

(51) Int. Cl. G06F 11/00

(52) U.S. Cl. 370/216

(57) ABSTRACT

The method collects configuration data about the network, compares it to known good configurations to see if a corrective configuration is available. In addition, the method will review known bad configurations and determine if any of the successful corrective configurations for the bad configuration would be appropriate for the bad configuration under consideration.

### BACKGROUND

This Background is intended to provide the basic context of this patent application and it is not intended to describe a specific problem to be solved.

Diagnosing network problems has long been a problem. Many manufactures and lots of different software combine to make identifying a specific cause of a network problem difficult. Often, friends are enlisted in the hopes that their experience in correcting their own network problems will be able to help clear up problems for the user.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

A method of diagnosing network problems is disclosed. The method collects configuration data about the network, compares it to known good configurations to see if a corrective configuration is available. In addition, the method will review known bad configurations and determine if any of the successful corrective configurations for the bad configuration would be appropriate for the bad configuration under consideration.

Networks and networked applications depend on several pieces of configuration information to operate correctly. Such information resides in routers, firewalls, and end hosts, among other places. Incorrect information, or mis-configuration, could interfere with the running of networked applications. This problem is particularly acute in consumer settings such as home networks, where there is a huge diversity of network elements and applications coupled with the absence of network administrators.

To address this problem, a system that leverages shared knowledge in a population of users to diagnose and resolve mis-configurations is disclosed. If one user has figured out the fix for a problem, this knowledge would be made available to another user experiencing the same problem through the system and method. The system and method records and aggregates configuration information from a large population of clients, annotates it with compact network problem signatures, looks up the appropriate information when a new client experiences a similar problem, and suggests configuration changes to resolve the problem.

### BRIEF DESCRIPTION OF THE DRAWINGS

FIG. 1 is an illustration of a system design;

FIG. 2 is an illustration of a configuration tree generated by the configuration manager for the IIS FTP server;

FIG. 3 is an illustration of a further method of using statistical analysis to further determine if a response from a participant is contradictory in an objective manner;

FIG. 4 illustrates an example of such a configuration tree that has been generated for the Microsoft Connection Manager VPN application;

FIG. 5 illustrates the signature tree and the suggestion table entries generated by the signature pruner and the configuration manager for the Connection Manager VPN client;

FIG. 6 illustrates the configuration tree for the Xbox 360 configuration data;

FIG. 7 illustrates the signature tree and the suggestion table entries generated for the Xbox 360 network signatures; and

FIG. 8 illustrates the sensitivity of the decision trees to mislabeled configuration data.

### SPECIFICATION

Although the following text sets forth a detailed description of numerous different embodiments, it should be understood that the legal scope of the description is defined by the words of the claims set forth at the end of this patent. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, it is not intended that the scope of any claim element be interpreted based on the application of 35 U.S.C. §112, sixth paragraph.

1. Introduction

A typical network comprises several components, including routers, firewalls, network address translation devices (NATs), dynamic host configuration protocol devices (DHCP), domain name system devices (DNS), servers, and clients. Configuration information residing in each component controls its behavior. For example, a router's configuration tells it who its neighbors are while a firewall's configuration tells it which traffic to block and which to let through. Correctness of the configuration information is thus critical to the proper functioning of the network and of networked applications. Mis-configuration can interfere with the running of these applications, leading to user frustration.

This problem is particularly acute in consumer settings such as home networks, where there is a huge diversity of network elements and applications, deployed without the benefit of vetting and standardization that is typical in enterprises, and an absence of network administrators. A home user with a network problem is often left helpless, not knowing which, if any, of a myriad of configuration settings to manipulate.

Nevertheless, it is often the case that a user is not the first one to encounter a problem. Other users may have encountered a similar or the same problem while running the same application with a similar or the same network setup. For example, a particular audio/video chat application may not work with a particular make and model of home router unless the client host is placed on the DMZ of the network. If one user discovers this fix, it can, in principle, be reused by another user faced with the same problem in a similar setting.

Motivated by this observation, a system that helps users diagnose network mis-configurations by leveraging the knowledge accumulated by a population of users has been developed and is described herein. In the figures and description, the system and method may be referred to as “NetPrints.” This approach is akin to how users today scour through online discussion forums looking for a solution to their problem, however, a key distinction is that the accumulation, indexing, and retrieval of shared knowledge happens automatically, with little human involvement.

The system and method may include client 200 and server 210 components. The client component 200 gathers configuration information from the client host and from network devices such as the home router 220 or NAT box. In addition, it may capture a trace of the network traffic 230 associated with an application run and extracts a set of features that characterize the corresponding network communication. The client component 200 may uploads its local configuration information along with the network traffic 230 features to the server 210. In addition, in the case of a failed application run, the user clicks a “help” button to invoke the method diagnostics. This may be the only human input needed to operate the method. The user input also may signal to the server 210 that the configuration information and network traffic features 230 just uploaded correspond to an unsuccessful run of the application. In other embodiments, human input is not needed and the system starts itself when a problem is encountered.

Anecdote 240 may be a term used to describe the combination of configuration information, network traffic 230 features, and the indication of whether or not an application run was successful. The server 210 may gather anecdotes 240 from clients 200 and construct a decision tree 250 for every application to represent the knowledge of good and bad configurations. It also may use a decision tree algorithm to identify the network traffic features that are important, thereby generating a network signature 260 for each application. In addition, the server 210 may maintain a suggestion table 270 where, indexed by the network signature, it stores a potential set of configuration fixes that other clients have previously reported as their solution to a similar problem.

When the server 210 is presented with a client request triggered by a user or system invoking “help”, it may walk down the decision tree 250 that codifies its knowledge and it identifies configuration changes that might help resolve the problem using a procedure referred to as configuration mutation. If the decision tree 250 traversal does not yield a suitable fix, the server may look up the suggestion table 270 for any isolated configuration changes that might solve the problem. If both the tree traversal 250 and the suggestion table 270 lookup fail in generating a configuration fix, the method may infer that the problem is not related to the client's home network configuration.

A sample list of twenty five configuration-related home networking problems and their resolutions drawn from online discussion boards, user surveys, and past experience in disclosed in Table I. All of these problems are amenable to resolution through the system and method. While the focus in this application is on home network settings, the method could be applied in other settings as well. Also, a focus is on network configuration problems that interfere with specific applications but do not result in full disconnection and in particular does not prevent communication with the server. Indeed, such subtle problems tend to be much more challenging to diagnose than full disconnection, which is often the result of a basic problem (e.g., the network cable not being plugged in) or a problem beyond the home network and hence the control of the end user (e.g., a disconnection at the ISP level). It may be possible to proactively pre-fetch and locally cache relevant information from the server (e.g., that pertaining to the specific make and model of router in a user's home network), to allow the method to still function in the event of a disconnection from the server 210 and to therefore target mis-configurations that cause total disconnection from the server.

Mis-configuration diagnosis has received much attention in recent years. To provide context for the challenges of diagnosing home network mis-configurations, a list of twenty five configuration-related home networking problems and their resolutions drawn from online discussion boards, user surveys, and experience is disclosed in Table I. Table I summarizes these problems, their cause, and the configuration changes required to fix them. Glancing through this table shows that many problems affect specific applications, that the causes can be subtle (e.g., no connectivity when STP is not disabled when connected to Comcast networks (#3)), and that the solutions can involve obscure configuration settings, particularly for home users (e.g., the suite of specific settings for the Xbox problem in #22).

A. Operation Overview

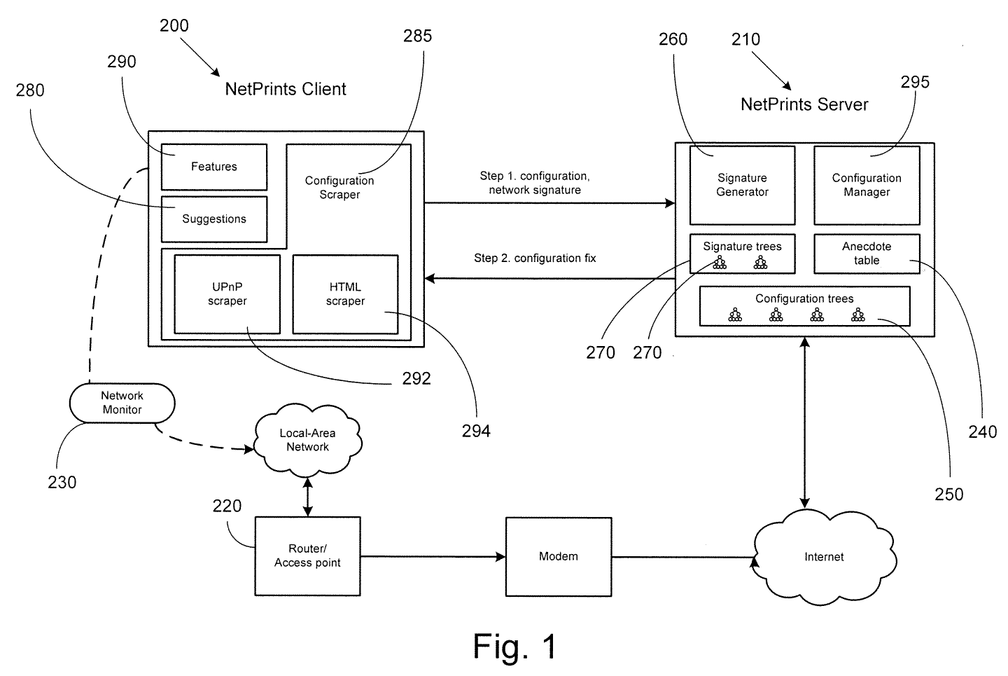

FIG. 1 shows a high-level depiction of the components used in embodiments of the system and method, both at the client 200 and the server 210, and how they interact. The system and method may have two modes of operation: the “normal” mode and the “diagnose” mode. In normal mode, the client 200 collects information about the normal mode of operation of the user's machine. It periodically determines the set of applications running, a feature vector that characterizes the network usage of each application, and the home network configuration. It reports a concise representation of this information to the server 210 whenever it detects a change since the last time it reported this information to the server 210. The server 210, in turn, uses this information to characterize the normal mode of operation for each application reported by the client. The method uses a black-box approach to operating on home network configurations. It does not interpret the semantics of any of the configuration fields and values used to diagnose network problems.

TABLE I
RECENT CONFIGURATION-RELATED PROBLEMS IN HOME NETWORKS.

| No. | Application | Router | Problem | Cause | Fix |
|---|---|---|---|---|---|
| 1. | BitTorrent | WRT54GL | Torrents seem to get extremely | NAT table filling up too fast | Decrease the NAT table timeout, |
| | | | slow after a while | | increase the max. no. of connections |
| | | | | | in the NAT table |
| 2. | File Sharing | WGT624 | Only unidirectional sharing: PC1 | Firewall is not properly configured | Allow file sharing through all |
| | | | is seen on PC2 but not vice versa | | firewalls |
| 3. | Generic | WRT54GL | Cannot access the network | STP (Spanning Tree Protocol) | Disable STP |
| | | | | not supported by Corncast | |
| 4. | Generic | Linksys | Cannot access the Internet though | Recent router change. ISP uses | Turn on MAC address cloning |
| | | | the LAN is working | MAC authentication, so disallows | |
| | | | | traffic from the new router | |
| 5. | IP Camera | DG834GT | Camera disconnects periodically | DHCP problem | Configure static IP on the camera |
| | | | at midnight, router needs reboot | | |
| 6. | Online Gaming | WGR614 | Disconnected from wireless network | (n/a) | Enable UPnP on router and gaming |
| | | | immediately or 30 sec into | | device |
| | | | playing | | |
| 7. | Office | WRTP54G | Instant Messenger client does not | DNS requests not getting resolved | Switch off DNS proxy on router |
| | Communicator | | connect from home | | |
| 8. | Outlook | WRT54G | Outlook does not connect via | Default IP range of router was | Change the IP range of router |
| | | | VPN to office | same as that of the office router | |
| 9. | Outlook | WGR614 | Router not able to email logs | SMTP server not configured | Setup SMTP server details in the |
| | | | | properly | router configuration |
| 10. | Outlook | Linksys | Not able so send Outlook messages | MTU value too high | Reduce MTU to 1458 or 1365 |
| | | | through Linksys router. | | |
| | | | Belkin router works fine. Linksys | | |
| | | | only receives messages | | |
| 11. | Outlook | WRT54G | Not able so send mail using Outlook | Specific ports not opened on the | Setup port triggering on router for |
| | | | | router | port 25 and 110 (smtp and pop3 |
| | | | | | resp) |
| 12. | ROKU | DIR-655 | ROKU did not work wish mixed | (n/a) | Change to mixed b and g mode |
| | | | b, g and n wireless modes | | |
| 13. | SSH | WGR614 | SSH client times out after 10 | NAT table entry times out | Change router or increase NAT |
| | | | minutes | | table timeout |
| 14. | SSH server | WRT54G | Not able so setup ssh | Port 22 not forwarded | Forward port 22 to correct IP |
| 15. | STEAM based | WGR614 | Listing game servers causes | The router misinterprets the sudden | Upgrade to latest firmware |
| | games | | connection drops | influx of data as an attack and | |
| | | | | drops connection | |
| 16. | Streaming Real | BEFW11s4 | Real streaming kills router | Firmware upgrade caused problems | Downgrade to previous firmware |
| | Media | | | | |
| 17. | Streaming | WGR614 | Streaming media is not played | SPI is enabled which drops the | Disable SPI in the router |
| | media | | | connection | configuration |
| 18. | VPN | WGR614 | VPN does not work with Cisco | Cisco client uses GRE protocol | Use a different router |
| | | | VPN Client | which is not supported with the | |
| | | | | router | |
| 19. | VPN | WRT54G | VPN drops connection after 3 | (n/a) | Set MTU to 1350-1400, uncheck |
| | | | minutes | | “block anonymous internet request”, |
| | | | | | “filter multicast boxes” in |
| | | | | | router configuration |
| 20. | VPN | WRT54G | No VPN connectivity | Old router firmware | Firmware upgrade |
| 21. | VPN server | WRT54G | PPTP server behind NAT does | IP of server is 192.168.1.109, | Use static IP outside DHCP range |
| | | | not work despite port forwarding | which is inside default DHCP | for server |
| | | | enabled on required ports and | range of router. Router sometimes | |
| | | | PPTP passthrough allowed | is not able to port forward | |
| | | | | to these IPs inside default range | |
| | | | | of router | |
| 22. | Xbox | WRT54G | Xbox does not connect and all | Some ports are blocked and NAT | Set static IP address on Xbox and |
| | | | games do not run | traversal is restricted | configure it as DMZ, enable port |
| | | | | | forwarding on UDP 88, TCP 3074 |
| | | | | | and UDP 3074, disable UPnP to |
| | | | | | open NAT |
| 23. | Xbox | WRT54G | Xbox works with wired network | WPA2 security is not supported | Change wireless security feature |
| | | | but not with wireless | | from WPA2 to WPA personal |
| | | | | | security |
| 24. | Xbox | WGR614 | Not able to host Halo3 games | NAT settings too strict | Set Xbox as DMZ |
| 25. | Xbox | WRT54G | 2 Xboxes behind same NAT don't | Router can't forward traffic on | DMZ one Xbox and port forward |
| | | | run simultaneously | one post to two different Xboxes | the other for ports 88 UDP and |
| | | | | | 3074 TCP and UDP |

When users experience a problem with a certain application, they click the “help” button on a simple GUI to ask the client 200 on their local machine to diagnose the problem. The client 200 can identify which application to diagnose automatically (e.g., the application corresponding to the last foreground window before running the client) or with the help of the user (e.g., ask the user click on the application window). The client then switches to the diagnose mode, in which it gathers the same information as in the normal mode. However, it labels the information as corresponding to a “bad” state (as there is a problem in running the application) and uploads this information to the server 210 (step 1 in FIG. 1). The server 210 compares this “bad” information with the “good” information (represented as a decision tree 250) it has gathered over time from clients 200 that ran this application successfully (i.e., corresponding to the normal mode of those clients 200). The server 210 then reports possible configuration fixes back the client 200 (step 2 in FIG. 1).

In some cases, the server 210 may not be in a position to diagnose the problem based on the configuration information that it has accumulated. This situation could happen because the server 210 has an insufficient volume of samples to be able to distinguish between good and bad configurations (e.g., the application might be new). It could also happen when the problem only impacts a subset of clients 200, so that the “problematic” configuration actually works well for the majority of clients (e.g., problems #3 and #4 in Table I). In such cases, suggestions 280 are used to try and resolve the problem. A suggestion 280 is an observation reported by a client 200 that says that a certain configuration change seems to have fixed the problem. The problem is identified using the network traffic 260 signature of a problematic run of the application. While not as authoritative as diagnosis based on the decision tree 250, suggestions 280 can nevertheless be useful in the method context, just as they are in the human context (e.g., on online discussion boards which discuss problems and potential fixes).

If neither the decision tree 250 nor the suggestion information 270 yields an answer—the configuration reported by a troubled client is not deemed “bad” and there are no suggestions 280 that apply to the application and its network signature—the method may not return any diagnosis or resolution steps. This response is appropriate as it may well be that the problem is unrelated to local network configuration, so any local resolution steps might do more harm than good.

The Client

The client 200, running as a background process on a computer within the home network, has three principal components: the configuration scraper 285, the per-application network traffic feature extractor 290 and the per-application suggestion generator 280.

Configuration Scraper

The configuration scraper 285 collects three kinds of information: a) Network identification information from the local host running the client: specifically, whether it is using the wireless interface, the wired interface, or both, and whether it is using a static IP address; b) Internet Gateway Device identification information, namely the make, model and firmware version of the device, which in most cases is a home router although in some cases it could be a DSL or cable modem and which is obtained using the UPnP interface that is supported by many Internet Gateway Devices (It also may use the UPnP interface to obtain the URL for the web interface to the device); and c) Network-specific configuration information from the device.

The configuration scraper 285 uses both the UPnP interface 292 and the web interface 294 that most routers and modems provide to glean configuration information such as port forwarding and triggering tables, MTU value, VPN passthrough parameters, DMZ settings and wireless security settings. On some routers, the port tables from the web page 294 and the port tables from the UPnP interface 292 were not kept consistent with each other. Consequently, the method may scrape and combine the tables from both interfaces. Some router firmware versions also allow the method to scrape the maximum NAT table size and the per-connection timeout for each table entry. These fields may be particularly useful in diagnosing problems such as #1 and #13 in Table I.

While the UPnP interface 292 may provide access to only device-identifying parameters and the UPnP port forwarding and port triggering tables, the web interface 294 may be richer but not standardized across routers. In particular, there is no standardized way for parsing the HTML to extract the (key,value) pairs defining the configuration. Consequently, the configuration scraper 285 uses several heuristics to extract configuration information from the router web pages. An alternative to parsing the HTML is to leverage the observation that each configuration web page of the device is typically an HTML form that includes a “submit” button. The method may invoke this button programmatically on each configuration web page (for example, using the WebBrowser .NET control on Windows). Doing so causes the submission of an HTTP POST or GET request containing all of the (key,value) pairs in an easy-to-parse form. For example, the body of the POST request might contain: submit button=index& change action=&submit type=&action=Apply& dhcp start=100&dhcp num=50&dhcp lease=1440. It is straightforward to extract the various DHCP-related configuration settings from this string. Through the WebBrowser .NET control, the HTTP request may be trapped and it may be prevented from being sent to the Internet Gateway Device so that the scraping technique is not intrusive and does not affect the Internet Gateway Device in any way.

Network Traffic Feature Extractor

The network traffic 230 feature extractor may characterize the network usage of each application running on the client machine. In one embodiment of the several embodiments, it may use the winpcap library and the IPHelpers API on Windows to tie all observed network traffic to the individual processes, and hence applications, running on the client machine. For each running application, it may extract a set of features by examining its network activity. These features form the feature vector for the application. Table II lists the set of features that may be extracted in the form of rules. For every application, the feature extractor creates a seven-bit feature vector. If at least one connection of an application satisfies any of these rules, the corresponding bit in the feature vector is set. The feature vector may also be extended to contain hierarchical data. Note that while all of the features considered at present are binary and that the system and method use a flat feature set, the feature set could be expanded to include non-binary features.

The set of features in Table II was identified based on empirical observations of the ways in which an application's network communication may typically fail. The first four features in the table capture various kinds of TCP-level issues that may be commonly see in malfunctioning applications. Several applications and services such as multimedia streaming, DNS and VPN clients use transport protocols other than TCP. For all of these, the lack of connectivity in one direction often indicates a networking problem. Consequently, features #5 and #6 may be included to capture the behavior of such applications. Feature #7 may characterize a total loss of connectivity for an application using any transport protocol; problems #12 and #23 in Table I, for instance, are scenarios which may use this feature.

TABLE II
NETWORK TRAFFIC FEATURES USED IN NETPRINTS.

| No. | Feature description | Evaluation Type |
|---|---|---|
| 1. | TCP: Three SYN no response | per-connection |
| 2. | TCP:RST after SYN | per-connection |
| 3. | TCP:RST after no activity for 2 mins | per-connection |
| 4. | TCP:RST after some data exchanged | per-connection |
| 5. | UDP: Data sent but not received | per-four-tuple |
| 6. | Other: Data sent but not received | per-IP address pair |
| 7 | All: No data sent or received | overall |

Table II. Network Traffic Features Used

The client 200 may associate the feature vector extracted from network traffic 230 with the corresponding application generating the traffic. A hash of the application binary image may be used as a unique application identifier. The gathered network configuration and the per-application network features form the basic unit of information, called the anecdote 240, that the server 210 uses to perform automatic diagnosis of mis-configurations. Note that the client 200 generates the network traffic feature vector during the execution lifetime of an application. This situation would be problematic for applications that are long running; for example, a web browser could remain open on a client machine and be used for days or weeks. One way of constructing the feature vector would be to consider the network activity of the application just within relatively short windows of time.

Suggestion Generator

The application may use the suggestion generator 280 to help recommend configuration fixes for new problems that new applications or routers may pose, or to solve obscure configuration problems such as #3 in Table I. When the user reports a problem that the application cannot immediately solve, the suggestion generator 280 on the client 200 starts tracking the configuration and the affected application using the configuration scraper 285 and the network traffic 230 feature extractor. If it perceives a change in configuration (likely entered manually) and, within a pre-defined time window, the application's networking problem disappears, the application infers that the configuration changes fixed the application's problem. It then creates a suggestion containing the application binary hash, the network traffic 230 feature vector, and the configuration fix, and uploads this suggestion 280 to the server 210. The server 210 may then use these suggestions 280 to generate configuration fixes that may not yet be captured in the decision tree of configurations.

Client Issues

Extracting the network traffic 230 feature vectors for an application requires capturing its traffic. One possibility is to do this continuously. This approach has the advantage that both successful and unsuccessful runs of an application would be captured automatically. In one embodiment of the several embodiments, the network signature generator may be split into two parts: a lightweight, continuously running component to capture selected packet headers and connection-to-process bindings, and a relatively more CPU-intensive component that creates the feature vector from the trace. This approach leads to low overhead.

An alternative embodiment may be to monitor applications when they start and to capture traffic only when the application is one for which the application has not already extracted the feature vectors since the last change in network configuration. While this alternative would further reduce the overhead, it would mean that when there is a failure of an application for which the feature vector has already been recorded (from a previous successful run) and users click “help”, they would have to run the application again for the application to capture traffic from the failed run.

C. The Server

As shown in FIG. 1, the server 210 has two major components: the configuration manager 295 and the network signature generator, each of which operates on a per-application basis. The configuration manager 295 may track configuration information from successful and unsuccessful runs of an application. When presented with a mis-configuration, it suggests changes to be made to the (bad) configuration to move it to a good state. This step may be referred to as configuration mutation. The network signature generator 260 prunes the network signatures uploaded by clients to the minimum set of features needed to characterize and differentiate between the different ways in which an application may fail.

Decision Trees

The application may use decision trees 250 as a basis for performing configuration mutation. A decision tree 250 is a predictive model that maps observations (e.g., a client's network configuration) to their target values or labels (e.g., “good” or “bad”). Each non-leaf node in the decision tree 250 corresponds to an attribute of the observation and the edges out of the node indicate values that this attribute can take. Thus, each leaf node corresponds to an entire observation and carries a label. Given a new observation, the application may start at the root of the decision tree 250, walk down the tree, taking branches corresponding to the individual attributes of the observation, until a leaf node is reached. The label on the leaf node identifies configurations as good or bad.

There are several algorithms for decision tree 250 learning, i.e., for inducing a decision tree 250 from labeled training data. A widely-used algorithm, C4.5 may be appropriate, which builds trees using the concept of information gain. The idea is to start with the root, and at each level of the tree choose that attribute to split the data which reduces the entropy by the maximum amount. The result may be that the branch points (i.e., non-leaf nodes with multiple children) at the higher levels of the tree correspond to attributes with greater predictive power, i.e., those with distinct values or value ranges corresponding to distinct labels.

When the training data is noisy (e.g., it contains mislabeled samples) or there are too few samples, there is the danger that the above algorithm will overfit the training data. To address this concern, decision tree 250 algorithms like C4.5 also include a pruning step, wherein some branches in the tree 250 are discarded so long as this does not result in a significant error with respect to the training data (a process called generalization). C4.5 uses a confidence threshold to determine when to stop pruning. In one embodiment, a default threshold may be used. A consequence of pruning is that if the number of samples is insufficient, these may not be reflected in the decision tree.

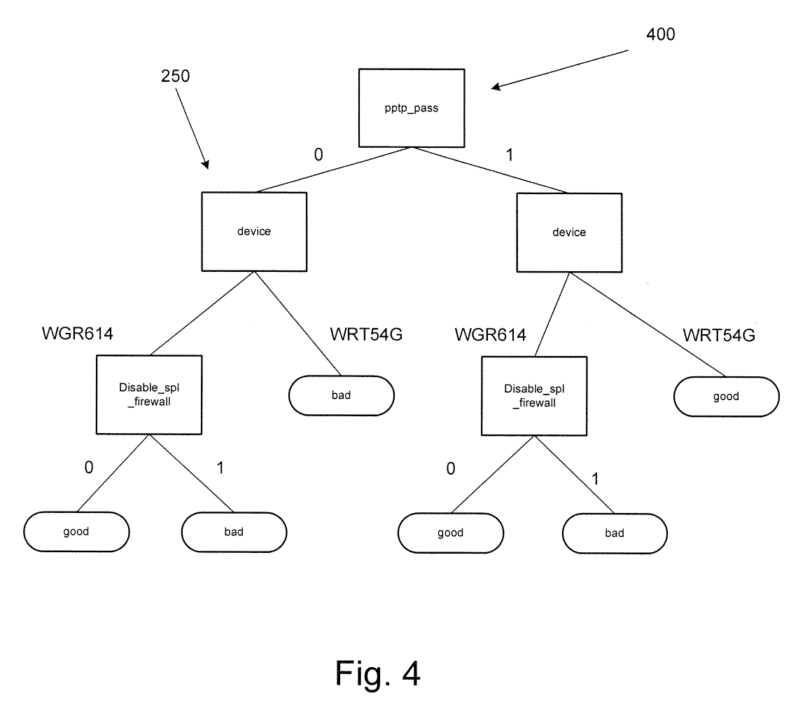

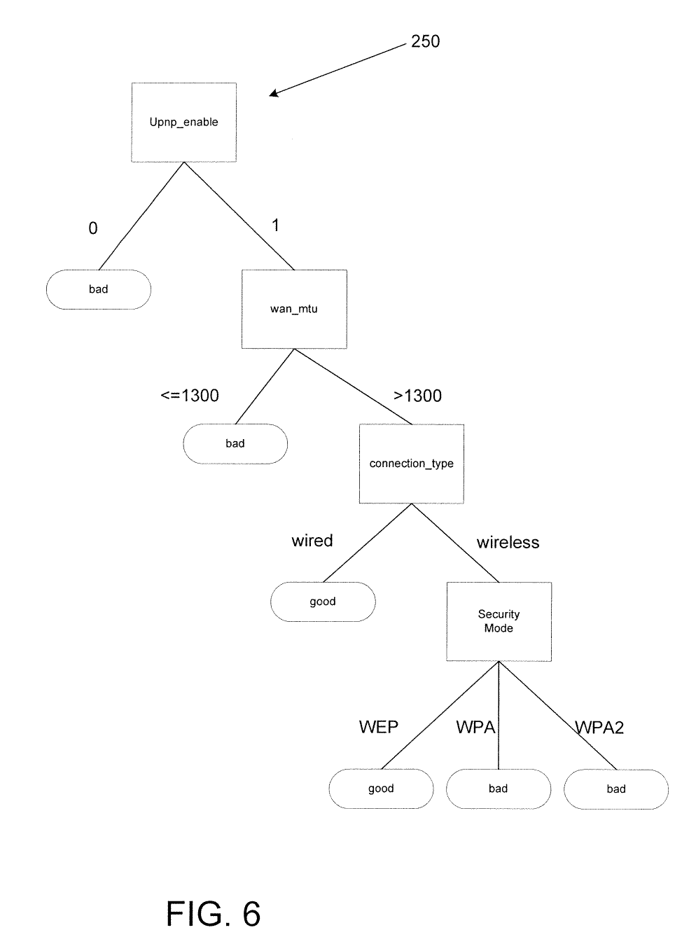

The decision tree 250 may have two notable properties. First, it enables classification of observations that include both quantitative and categorical attributes. For example, the decision tree in FIG. 6 includes quantitative attributes such as the WAN MTU and categorical attributes such as the security mode. Second, the decision tree 250 is amenable to easy interpretation. It not only enables classification of observations, it also helps identify in what minimal way an observation could be mutated so as it change its label (e.g., from “bad” to “good”). With a decision tree 250, the application may walk up the tree until it hits a branch point that includes a leaf with the desired label as a descendant, and then walk down the tree to that leaf node. For example, in FIG. 4, the mutation needed for a WGR614 router to move to a “good” state, with stateful packet inspection (SPI) disabled, would be to enable SPI.

The above properties make decision trees 250 attractive in the context of NetPrints compared to alternatives such as SVMs or Bayesian classification. Both configuration management and network signature generation require the ability to work with quantitative as well as categorical attributes. Furthermore, configuration management may benefit from the interpretability that decision trees 250, unlike SVMs or Bayesian classifiers provide. This interpretability enables the configuration mutation step that allows the server to suggest suitable configuration changes to fix problems.

Configuration Manager

The configuration manager 295 may use the configuration information submitted by clients to learn and construct per-application configuration trees 250 using C4.5. Note that configuration information submitted when the user clicks the “help” button may be labeled as “bad”; otherwise, it is labeled as “good.” The default configuration information uploaded is considered “good”.

FIG. 4 shows an example of such a configuration tree 250 that may be generated, using the C4.5 decision tree learning algorithm, for the Microsoft Connection Manager VPN application using configuration information from clients using two different models of routers: the Linksys WRT54G and the Netgear WGR614v5. The pptp passthrough attribute (corresponding to whether PPTP pass-through is enabled) is the clearest, even if not a perfect, indicator of whether a configuration is good or bad. Accordingly, it is at the root 400 of the decision tree 250.

Algorithm 1 Configuration mutation algorithm to move from a bad state to a good state.

1: sub find good conf(bad leaf)
2: parent node = parent(bad leaf node)
3: good leaf node = find good leaf(parent node)
4: conf .x = traverse tree(parent node, good leaf node)
5: return
6: end sub
7: sub find good leaf(node)
8: if is good leaf(node) then
9: return node
10: else
11: for all child node of node do
12: good leaf node = find good leaf(child node)
13: good leaf node
14: end for
15: end if
16: end sub

Algorithm 1 shows an algorithm that the configuration manager may use to suggest suitable configuration changes to the client. With this algorithm, the application uses the subtree from a branch of the nearest parent node 400 for searching for a path that ends in a good configuration. The configuration fields along this path are the candidates for moving the configuration from a bad state to a good state. In an alternate embodiment, the server can enumerate all path traversals from the bad leaf, corresponding to a bad configuration, to all good leafs, and then chooses the path traversal that requires the minimum number of configuration changes. This approach results in minimal configuration changes for solving the problem. Network signature generator

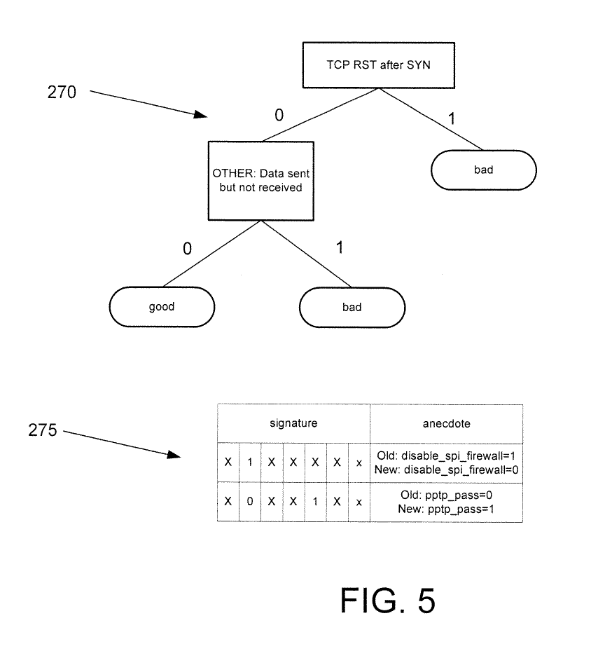

The server 210 also constructs per-application signature trees 270 to reduce the network traffic feature vectors submitted by clients down to the most significant features. The signature generator 260 again uses the C4.5 algorithm for this purpose. FIG. 5 shows the signature tree 270 generated for the Microsoft Connection Manager VPN application. Of all of the network features classified as good or bad, the signature tree 270 structure shows that only two important features are sufficient to capture all the networking problems that the Connection Manager application commonly sees.

Diagnosis Procedure

When a client uploads a good configuration and the corresponding application network traffic 230 feature vector, the configuration manager 295 and the signature generator 260 may use this to train the configuration tree 250 and the signature tree 270, respectively. Currently, the decision tree algorithm does not allow for incremental training of the trees, hence a cache of configurations may be used to perform the training at each step.

Diagnosis mode: When a client uploads a presumed-to-be-bad configuration along with a malfunctioning application's network feature vector, the configuration manager 295 and the signature generator 260 at the server 210 again use this information to train their respective trees (configuration tree 250 and signature tree 270). In addition, the server 210 proceeds to diagnose the problem.

As the first step towards diagnosis, the server 210 traverses the tree 250 top-down, using the presumed-to-be-bad configuration. If this traversal ends at a leaf node that is labeled as “bad”, the configuration manager 295 uses Algorithm 1 to find an alternate path from the root to a leaf node that is labeled “good.” It uses this alternate path to generate a set of configuration changes that it then conveys back to the client for presentation to the user.

However, it is possible that the top-down traversal of the tree with the presumed-to-be-bad configuration in fact ends at a “good” leaf node. Such a case can arise if: (a) the problem that the client has encountered is relatively new (e.g., because it involves a new application) and so has had an insufficient volume of training samples reported for it to have been incorporated in the configuration tree 250; (b) the problem only impacts a small subset of clients (e.g., problem #3 with STP and Comcast in Table I) so that the same configuration is reported as good by the majority of clients; (c) the configuration information being reported by the clients is not rich enough; or (d) the failure is not due to local mis-configuration.

The server 210 constructs and maintains a suggestion table 275 to address cases (a) and (b). The suggestion table 275 may be populated with the suggestions contributed by clients and indexed by the network signature of the application before the suggested fix was applied. As the accumulated volume of suggestions would keep growing, the server 210 only remembers a small, fixed number of the most recent distinct suggestions for any given application network signature.

In the event that the configuration information submitted by a complaining client is found to be “good”, the server 210 uses the network signature submitted to look up the suggestion table 275. If one or more suggestions is found, it returns these to the client 200.

If the suggestion table 275 also does not return an answer, the application declares that it is unable to diagnose the problem. This result would be appropriate in some cases as the problem may not be related to local configuration at all (case (d) above). However, if in fact the problem is that some critical configuration information is not being captured by the application (case (c)), the client-side scraper 200 may be augmented to extract this additional information.

### IV. EXAMPLES

A. Methodology

Using three routers, the Linksys WRT54G, Linksys WRTP54G and Netgear WGR614, as examples, some of the problems specified in Table I may be reviewed. These problems may be outlined in Table III. However, for the example reported here, three applications are reviewed—the IIS FTP server, the Microsoft Connection Manager VPN client, and the Xbox 360 gaming console—and two routers—Linksys WRT54G and Netgear WGR614—to illustrate the application ability to detect and correct misconfigurations. These example applications often have problems related to services running behind NATs, VPN clients, and gaming systems are reported as significant pain-points on the problem forums, as reflected in Table I.

Each application may be operated in different home-networking environments created by varying the home router (Linksys WRT54G or Netgear WGR614), the type of medium used (wired or wireless), and the configuration settings on the router. From various home router forums such as the Netgear and Linksys help forums, Microsoft support web pages, and third-party firmware forums, a list of typical configuration parameters that users modify on their routers may be created. The exact parameter names may be determined and the process of varying their settings may be automated using the HTTP POST mechanism explained previously. The details of these configuration parameters are explained below, with the values that each parameter was set to shown in parentheses.

1) MTU size (1100, 1200, 1300, 1400, 1500). Both the Linksys and the Netgear routers used the variable wan mtu to specify this.

2) VPN-specific passthrough fields (on or off). These parameters may be available only on the Linksys router. It may use three binary variables for VPN-based filtering: ipsec_passthrough, pptp_passthrough, and 12tp_passthrough.

3) Stateful Packet Inspection (SPI) firewall (on or off). This parameter may be available only on the Netgear router through the disable spi firewall binary variable.

4) Wireless security parameters (disabled, WEP, WPA or WPA2). The Netgear router may use the security type variable to specify the type of wireless security and the Linksys router may use SecurityMode. Also, the Netgear router may not support WPA2.

5) DMZ (on or off). Both routers may use the variable dmz enable.

6) UPnP (on or off). Both routers may use the variable upnp enable.

These configuration settings may be varied on the router. For each setting, the application may be run and used the application client's network feature extractor to create the feature vector for the application which may be combined with the configuration information to create an anecdote for the run. When the application worked as expected, the anecdote may be labeled as “good”. For the runs in which the application encountered networking problems, the anecdote may be labeled as “bad”. This collection of anecdotes may be used to generate the results presented here.

For the evaluation, all of the anecdotes 240 may be inputted to the server's configuration manager 295 and network signature generator 260 which then generate configuration trees 250 and signature trees 270 that capture all of the problems seen in these specific applications. The experiments may use the same collection of anecdotes 240 to vary the proportion of good and bad configurations, the diversity in the configuration information, and data set size to show the application's robustness in generating the correct configuration and signature trees 270 and in identifying suitable configuration mutations to fix problems.

TABLE III
PROBLEMS WE RECREATED

| No. | Problem | Router | Bad configuration |
|---|---|---|---|
| 1. | Connection Manager fails to connect | Netgear WGR614 | SPI firewall disabled |
| 2. | Connection Manager fails to connect | Linksys WRT54G | pptp-passthrough disabled |
| 3. | FTP connections fail to an FTP server | Linksys WRT54G, | No DMZ set |
| | behind a NAT | Netgear WRT54G | |
| 4. | Office Communicator (IM) did not | Linksys WRTP54G | DNS proxy enabled |
| | connect | (VoIP) | |
| 5. | Remote Desktop Connection fails | Linksys WRT54G | No port forwarding enabled |
| 6. | SSH connection times out after 10 minutes | Netgear WGR614 | NAT table timeout too short |
| | | | (10 minutes) |
| 7. | SSH connection times out after 30 minutes | Linksys WRT54G | NAT table timeout too short |
| | | | (30 minutes) |
| 8. | Xbox 360 does not connect to Xbox Live | Linksys WRT54G, | MTU < 1365 |
| | | Netgear WGR614 | |
| 9. | Xbox 360 does not connect to the | Linksys WRT54G | WPA2 turned on |
| | wireless network | | |
| 10. | Xbox 360 does not detect an open NAT | Linksys WRT54G, | UPnP turned off |
| | | Netgear WGR614 | |

B. IIS FTP Server

Usually, people set up FTP servers behind their NATs so that they and people they know can have easy access to data on their local computers from a remote location. The forums showed that a number of people complain about their service not running as expected behind a NAT. To emulate this situation, a first evaluation of the application was on the IIS FTP server running behind a NAT. While varying the configuration, a remote FTP client may be used to connect to this server. When the connection failed, the anecdote may be labeled as bad. All other anecdotes may be labeled good. In this experiment, 128 distinct anecdotes may be used, with 64 each labeled as good and bad.

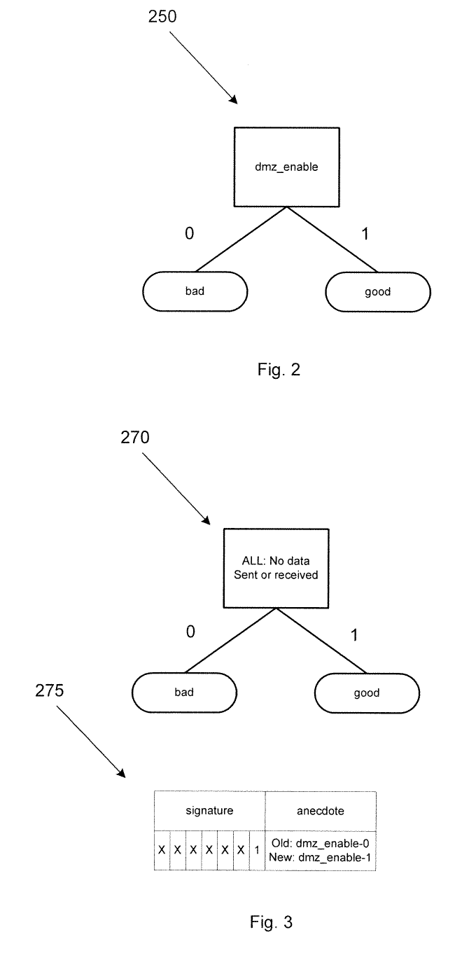

FIG. 2 illustrates that the configuration tree 250 that the application generates using these anecdotes 240. The configuration tree clearly captures the fact that when the variable dmz enable was set, the FTP server worked. Therefore, for any new anecdote 240 for this FTP server that is labeled as bad, the configuration mutation would involve changing the dmz enable field from 0 to 1.

FIG. 3. illustrates the signature tree 270 and the suggestion table 275 entries generated by the signature generator 260 and the configuration manager 295 for the IIS FTP Server using anecdotes 240. The differentiating feature in this case is feature no. 7 in Table II. The server 210 determines the problem signatures to enter into the per-application suggestion table 275 by traversing the tree from root to every bad leaf. It sets the value of all the features that it does not see during the traversal as a don't care value, “X”. In this experiment, since the FTP server ran into only one kind of problem, the server 210 generated only one signature, with all values except the 7th value set to X. If and when a client 200 reports that a particular configuration change fixed a problem (i.e., it makes a suggestion), with a feature vector matching this signature, the server 210 makes an entry in the suggestion table 275 indexed by the signature.

C. Microsoft Connection Manager

The Microsoft Connection Manager is a PPTP-based VPN client. To collect anecdotes 240 with the Connection Manager, the router 220 configuration may be varied and, for each configuration, the application may try to connect the client to a VPN server. If the VPN connection was successful, the anecdote 240 was labeled as good, and if the connection did not go through, the anecdote 240 may be labeled as bad. The application may collected 360 anecdotes 240 using the Linksys router, of which in 120 cases the VPN client connected successfully to the server (210), and 120 runs using the Netgear router, of which the VPN client connected successfully to the server (210) 60 times.

FIG. 4 illustrates the configuration tree for the Connection Manager 295 application that the application server 210 generated. Of all the configuration parameters, the configuration manager 295 picked pptp_passthrough, device, and disable_spi_firewall as the discerning configuration parameters. Therefore, from the anecdotes, the application automatically identifies that the connection manager fails to connect through the Netgear WGR614 router if disable_spi_firewall is turned on, and it fails to connect through the Linksys WRT54G router when pptp_passthrough is disabled. The configuration mutation step will therefore suggest changing bad configurations by changing pptp_passthroughfrom 0 to 1 or changing disable_spi_fi rewal from to 0, depending on the router used. This matches with the three problem scenarios that were manually reproduced for the VPN client, shown in Table III.

FIG. 5 shows the signature tree 270 that the signature generator 260 creates for the Connection Manager 295. Of the seven features shown in Table II, only two features appeared to be most discerning—“TCP:RST after SYN” and “OTHER: Data sent but not received”. It turns out that the feature vectors in the bad anecdotes 240 that the Netgear WGR614 router generates almost always have the former feature set, while a large percentage of the bad anecdotes 240 that the Linksys router generates have the latter feature set. The C4.5 algorithm, therefore, automatically extracts these in the signature tree 270. The signature generator 260 uses the signature tree 270 to generate signatures for every problem. these signatures are then used as indices into the suggestion table 275. FIG. 5 shows the two signatures that are created and used to index the suggestion table.

Xbox 360

Xbox Live is a service that allows Xbox users to play single-player and multi-player games, chat, and interact over the network. When the game “Halo 3” released, a large amount of activity on the different forums occurred discussing home networking issues that hindered online multi-player gaming with Xbox 360 and Xbox Live. Consequently, an evaluation of how the Xbox 360 interacted with the Xbox Live service under different routers and router configuration settings makes sense.

One problem that arose during this experiment was that the application's client's feature extractor could not be run directly on the Xbox as it is not user-programmable. Xbox Development kits are available at a much higher price than consumer Xboxes so the application could, in principle, be ported to the Xbox. However, for the sake of this example, the client may be emulated on the Xbox by instead running the client on a PC that is able to monitor all of the Xbox's network communication. In the wired network scenario, the PC may be set to be in bridge mode, placed in between the Xbox and the home router. For the wireless case, a PC may be used, with a wireless interface set in monitor mode, to sniff all packets to and from the Xbox.

In total, 147 anecdotes 240 were collected with the Linksys WRT54G and 100 anecdotes using the Netgear WGR614 router while varying the configurations. Of the anecdotes (240), 50 of the former and 50 of the latter were good anecdotes 240. The methodology to determine whether the Xbox was suitably connected to Xbox Live was to run the “Test Live Connection” tool from the Xbox Dashboard. This tool checks that the Xbox 360 is connected to the network, either via a wired or a wireless connection, and that it has a valid IP address and a DNS server setting. It uses a specific test server to check whether the home router handles ICMP messages as expected, and to check the MTU value of the router. If any of these tests fail, the tool reports an error. The test also classifies the NAT on the router as one of “open”, “moderate” or “strict”, depending on the port assignment policy and the port filtering policy of the NAT. Xbox Live users prefer to have an open NAT because this gives them the maximum functionality and highest performance while playing online games. Therefore any anecdote for which the tests fail, or for which the NAT is labeled as “moderate” or “strict”, is labeled as bad.

FIG. 6 shows the server's 210 configuration tree 250 generated using the Xbox's anecdotes 240. There were three mis-configurations that the configuration manager 295 learned from the anecdotes 240. First, to make the NAT open, the router needs to enable UPnP. Second, the Xbox requires the MTU value set to be set to greater than 1300 for it to able to connect to Xbox Live. Third, the Xbox wireless adapter could not connect to a wireless network if the security mode used was WPA2.

The application's findings are the same as the configuration fixes that were manually generated and show in Table III, except for the MTU fix. Both the Xbox dashboard tool and on the support pages that the Xbox Live service indicated that the MTU should be set to 1365 or higher for a connection to succeed. The experiment illustrates that the server can capture and solve a mix of different kinds of configuration issues: a general error (unnp_enable needs to be on), a service requirement (wan_mtu needs to be set higher than 13645), and an unsupported feature (WPA2 not supported).

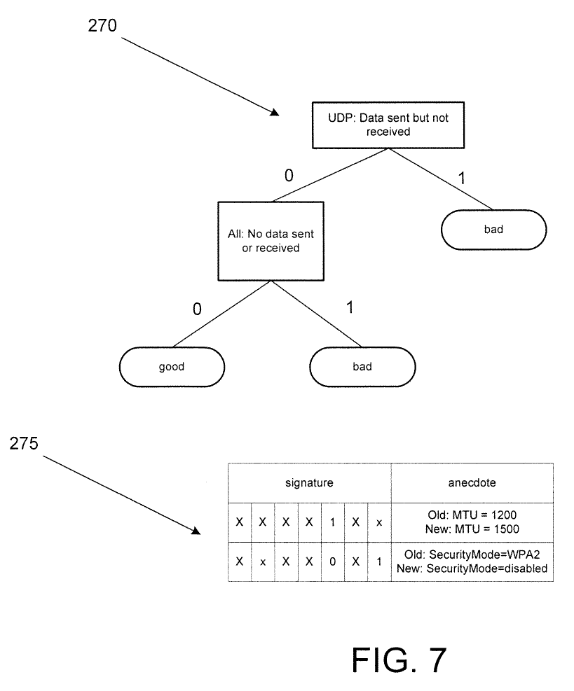

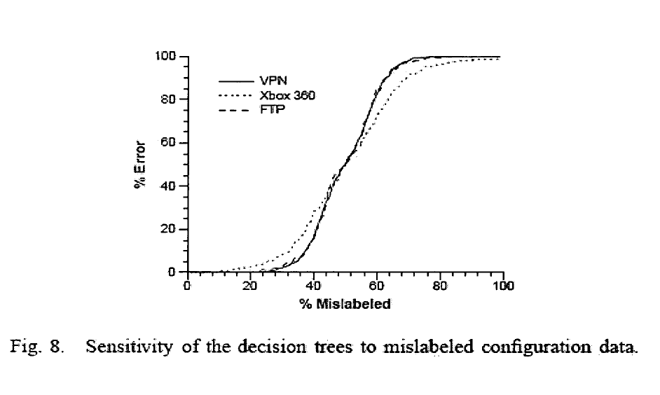

FIG. 7 shows the signature tree 270 that the application generates for the Xbox. Although the application detected three problem configuration values in this experiment, the signature tree 270 appears to capture only two features as problematic: ALL:no data sent or received, and UDP:Data sent but not received. It turns out that the feature vector did not capture the difference between having the NAT in moderate or strict mode and having it in open mode. (Indeed, this configuration setting only has a bearing on functionality such as hosting games.) While this would impact our ability to use the network signature to index the corresponding suggestions, the configuration tree (which in any case is NetPrints' first line of defense) nevertheless captures the relevant configuration information (upnp enable).

As with any system that collects information from users, privacy is important. Privacy of an individual user may be ensuring that we do not collect any identifying information, such as the PPPoE login and password, the ISP name, WAN IP address, the DNS server addresses, or the wireless SSID. None of the configuration fixes that the server 210 proposes do not involve any of these sensitive fields. Furthermore, the network signatures derived from tracing the network capture only very high-level information (e.g., three TCP SYNs without a response) and no raw packet data.

Proactive and reactive operations. The application works reactively, i.e., it only solves a problem if a client reports it but it may also work proactively in providing configuration changes to the client. Given the knowledge of the set of applications running on the client, the server could anticipate potential configuration-related problems and suggest preventive configuration changes.

The application may operate in other environments. While the application targets the home network, the design methodology is equally applicable to other settings such as large enterprise networks that have different kinds of networking devices, configurations and network topologies.

1. A method of diagnosis problems on a network comprising:
If the network is operating properly, communicating non-problematic configuration data of a network to a central storage;
If the network has basic connectivity to the Internet but is operating improperly,
Collecting problematic configuration data;
Communicating the problematic configuration data to the central storage wherein the problematic configuration data is compared to configuration data previously stored for networks operating properly and for network behaving improperly;
Receiving from the central storage suggested corrected configuration data wherein the suggested configuration data comprises data selected from a group comprising:
Non-problematic configuration data that is known to have worked in the past;
Corrective configuration data wherein corrective configuration data comprises configuration data that successfully corrected the problematic configuration data in the past;
Adjusting the configuration based on the suggested configuration data.

2. The method of claim 1, further comprising using a decision tree to select the most probable corrective configuration data.

3. The method of claim 2, further comprising suggesting a plurality of corrective configurations.

4. The method of claim 1, further comprising if a new application is added to a system that will create a new configuration, determining whether the new configuration has been identified as a problematic configuration.

5. The method of claim 4, further compromising if the new configuration is a problematic configuration, supplying a corrective configuration.

6. The method of claim 1, wherein the non-problematic configuration data and the problematic configuration data are obtained from at least one selected from a group comprising:
network identification information;
internet gateway device identification information; and
network specific configuration information from the device.

7. The method of claim 1, wherein the configuration data comprises data regarding the application running, a feature vector and data regarding a network configuration wherein the feature vector further comprises a representation of the network usage of each application.

8. The method of claim 1, further comprising using a configuration scraper, a network traffic manager and a suggestion generator to collect configuration data to be communicated to the central server wherein the configuration scraper further comprises collecting configuration data comprising network identification information, internet gateway device identification information and network specific configuration information.

9. The method of claim 8, further comprising using UPnP scrapers and HTML scrapers to obtain configuration data.

10. The method of claim 9, further comprising using HTTP form submit operations to generate HTTP requests to Internet Gateway Devices, and to obtain configuration data by parsing the GET and POST strings from these HTTP requests.

11. The method of claim 1, further comprising using a signature generator for constructing per-application signature trees to reduce the network traffic feature vectors submitted by clients down to the most significant features.

12. The method of claim 1, further comprising storing configuration information in a structured way using decision tree learning and diagnosing a configuration problem using an algorithm to traverse the decision tree from a bad leaf node to a good leaf node wherein the good leaf node comprises suggested configuration data.

13. The method of claim 1, further comprising constructing a suggestion table to store suggestions contributed by clients wherein the suggestions are indexed by the network signature of the application-specific problem before the suggested fix was applied.

14. A computing device comprising a processor for executing computer executable instructions, a memory for storing computer executable instructions, the computer executable instructions comprising instructions for executing a method of diagnosis problems on a network, the computer executable instructions comprising instructions for:

15. The computing device of claim 14, further comprising computer executable instructions for:
If the network is operating properly, communicating non-problematic configuration data of a network to a central storage wherein the configuration data comprises data regarding the application running, a feature vector and data regarding a network configuration and wherein the non-problematic configuration data is obtained from at least one selected from a group comprising:
network identification information;
internet gateway device identification information; and
network specific configuration information from the device;
If the network has basic connectivity to the Internet but is operating improperly,
Collecting problematic configuration data wherein the configuration data comprises data regarding the application running, a feature vector and data regarding a network configuration and wherein the problematic configuration data is obtained from at least one selected from a group comprising:
network identification information;
internet gateway device identification information; and
network specific configuration information from the device;
Communicating the problematic configuration data to the central storage wherein the problematic configuration data is compared to configuration data previously stored for networks operating properly and for network behaving improperly;
Receiving from the central storage suggested corrected configuration data wherein the suggested configuration data comprises data selected from a group comprising:
Non-problematic configuration data that is known to have worked in the past;
Corrective configuration data wherein corrective configuration data comprises configuration data that successfully corrected the problematic configuration data in the past;
Adjusting the configuration based on the suggested configuration data.

16. The computing device of claim 14, further comprising computer executable instructions for collecting configuration data to be communicated to the central server, the collection further comprising using at least one selected from a group comprising:
a configuration scraper further comprising UPnP scrapers and HTML scrapers,
a network traffic manager and
a suggestion generator to collect configuration data to be communicated to the central server.

17. The computing device of claim 14, wherein the configuration scraper further comprises collecting configuration data comprising network identification information, internet gateway device identification information and network specific configuration information.

18. A computing storage medium for storing computer executable instruction to be executed by a processor, the computer executable instructions comprising instructions for executing a method of diagnosing problems on a home network, the computer executable instructions comprising instructions for:
If the network is operating properly, communicating non-problematic configuration data of a network to a central storage wherein the configuration data comprises data regarding the application running, a feature vector and data regarding a network configuration and wherein the non-problematic configuration data is obtained from at least one selected from a group comprising:
network identification information;
internet gateway device identification information; and
network specific configuration information from the device;
If the network has basic connectivity to the Internet but is operating improperly,
Collecting problematic configuration data wherein the configuration data comprises data regarding the application running, a feature vector and data regarding a network configuration and wherein the problematic configuration data is obtained from at least one selected from a group comprising:
network identification information;
internet gateway device identification information; and
network specific configuration information from the device;
Communicating the problematic configuration data to the central storage wherein the problematic configuration data is compared to configuration data previously stored for networks operating properly and for network behaving improperly;
Receiving from the central storage suggested corrected configuration data wherein the suggested configuration data comprises data selected from a group comprising:
Non-problematic configuration data that is known to have worked in the past;
Corrective configuration data wherein corrective configuration data comprises configuration data that successfully corrected the problematic configuration data in the past;
Adjusting the configuration based on the suggested configuration data.

19. The computer storage medium of claim 18, further comprising instructions for:
if a new application is added to a system that will create a new configuration, determining whether the new configuration has been identified as a problematic configuration and
if the new configuration is determined to be a problematic configuration, supplying a corrective configuration.

20. The computer storage medium of claim 18, further comprising storing configuration information in a structured way using decision tree learning and diagnosing a configuration problem using an algorithm to traverse the decision tree from a bad leaf node to a good leaf node wherein the good leaf node comprises suggested configuration data.
